(19) United States
(12) Patent Application Publication
(10) Pub. No.: US 2011/0274526 A1
(43) Pub. Date: Nov. 10, 2011

(54) DOCK DOLLY

(76) Inventor: Richard L. Kusick, New Brighton, MN (US)

(21) Appl. No.: 13/027,035

(22) Filed: Feb. 14, 2011

Related U.S. Application Data
(60) Provisional application No. 61/303,801, filed on Feb. 12, 2010.

(51) Int. Cl. B62B 1/06; B62B 1/04

(52) U.S. Cl. 414/457; 414/800

(57) ABSTRACT

A dolly for supporting an end of a dock and translationally shifting the dock, the dock having side frame members and being supported proximate a first end by a plurality of wheels, includes first and second engaging members disposable adjacent a respective dock side, the first and second engaging members being adapted to selectively engage a respective dock side frame member.

### RELATED APPLICATION

The present application claims the benefit of U.S. Provisional Application No. 61/303,801 filed Feb. 12, 2010, which is incorporated herein in its entirety by reference.

### TECHNICAL FIELD OF THE INVENTION

The present invention relates to dollies or trolleys useful in transporting objects. More particularly, the present invention relates to a dolly for lifting and transporting a dock structure.

### BACKGROUND OF THE INVENTION

Removable docks or piers are often used in climate regions where, in the winter or off-season, the weather is cold enough to freeze surface waters around the dock. Once frozen, ice has a tendency to shift over the course of the season. If a dock is left in the ice, several different types of damage can occur, including lifting damage, where the dock is actually forced upward by fluctuating water levels, as well as expansion damage, which can exert large amounts of pressure on the decking and adjoining pilings. Thus, it is prudent to remove docks from water before the water freezes.

To that end, roll-in docks have become increasingly popular to aid in reducing the cost and effort needed to install the dock at the beginning of the season and remove the dock at the end of the season. Roll-in docks generally have an axle with wheels coupled to the axle on the lake-side end of the dock (which enters the lake first when installing). With such a design, much of the weight is forced down on the axle and wheels, thus making the entire dock structure rollable and easier to move. However, because of its weight, the dock typically requires a dolly or mechanical means for lifting and transporting the opposite, non-wheeled side.

Currently, solutions for lifting and transporting roll-in docks include a dolly utilizing a lifting plate that slides under the non-wheeled end of the dock in combination with a winch to operate the lifting and towing. Further, myriad human-powered dollies exist, but most are adapted to operate on objects like boats, snowmobiles, plates, and skids, etc. Using these dollies in dock applications could lead to cumbersome and potentially dangerous results, especially with the wide variety of dock sizes and shapes. Therefore, there is a need for a human-powered dolly adapted to lift and transport roll-in docks of varying sizes.

### SUMMARY OF THE INVENTION

The device of the present application substantially meets the aforementioned needs of the industry. The dock dolly provides a mechanical means for easily lifting the lakeshore end of a roll-in dock in order to transport the dock into or out of the water.

In one embodiment of the present invention, the dock dolly requires only human force in order to lift and transport a roll-in dock. The dolly is designed such that when the engaging members engage the dock, the dock handle is in a generally vertical position. Only a fraction of the weight of the dock is needed to be applied to the handle in order to transfer the majority of the dock weight to the axle, thus lifting the dock and allowing it to roll easily. Further, the handle is adjustable in height to allow for increased or decreased leverage, depending on the size and positioning of the dock, as well as the environment in which the dock sits.

Additionally, the engaging members are disposable adjacent the respective sides of the dock and engaging the dock from that disposition. As result of employing side-engaging members, the dock dolly is capable of lifting and transporting many different sizes of docks. In an embodiment, the engaging members are easily slidable along the axle, thus allowing for an easy transition to a loading position wherein the dolly is engaged with the dock. Further, a square axle ensures that the two engaging arms extend from the axle at the same angle, thus providing a consistent lift between the two arms. Also, the square axle provides additional resistance against engaging arm slippage, should the integrity of the mechanical fastener that joins each arm to the axle be compromised.

In another preferred embodiment, the engaging members have a fixed distance apart and employ an aperture for capturing a bar that is extendable form side to side of the dock frame. The bar is long enough that it is capable of extending through both of the apertures.

Further, the dolly provides slip-free lifting and transporting. Each engaging arm comprises an inward-facing pin that provides the lifting point between the dolly and the dock. Further, each inward-facing pin comprises a circular lip at the end of the pin so that each engaging arm remains engaged with the dock while the dolly is lifting, thus preventing any potential slipping.

Also, the dock dolly of the present invention provides a means for easily pushing a roll-in dock. In one embodiment, each engaging arm comprises a push bracket that extends vertically from the distal end of the arm. The two parallel push brackets, when coupled with a board, create an ideal backstop for resting the end of the dock in order to push it. In another embodiment, the push bracket extends from an intermediate area along the engaging arm.

The dock dolly of the present invention is also adapted for use with an all-terrain or other vehicle, or a winch. The handle comprises one or more slotted flanges for coupling a cable from the dolly to the vehicle or winch. In one embodiment, a single slotted flange is affixed at the center of the handle. In another embodiment, two slotted flanges are affixed at the same distance from the respective ends of the handle. It is the vehicle or winch, via the coupled cable, that provides the downward and backward or forward force for moving the dolly and subsequently the dock.

Further, the dock dolly of the present invention has wheels that are specifically designed for lakeside environments. In an embodiment, the wheels are made of lightweight plastic, thus making the dolly easy to carry. Further, the tread area is wide and textured just like a dock wheel, making the dolly easily rollable on sand and other lakeside surfaces.

### BRIEF DESCRIPTION OF THE DRAWINGS

The invention may be more completely understood in consideration of the following detailed description of various embodiments of the invention, in connection with the accompanying drawings, in which:

FIG. 1 is a perspective view of a dock dolly according to an embodiment of the present invention;

FIG. 2a is a front elevational view of the scope of positioning of the arms of the dock dolly of FIG. 1 according to an embodiment;

FIG. 2b is a front elevational view of the arms of the dock dolly of FIG. 1 engaging a dock according to an embodiment;

FIG. 3a is a side elevational view of the dock dolly of FIG. 1 in a loading position according to an embodiment;

FIG. 3b is a side elevational view of the dock dolly of FIG. 1 in a transport position according to an embodiment;

FIG. 4 is a perspective view of a dock dolly engaging a dock with a lifting rod according to another embodiment of the invention; and

FIG. 5 is a side elevational view of the dock dolly of FIG. 4 in a transport position according to an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims and their equivalents.

### DETAILED DESCRIPTION OF THE DRAWINGS

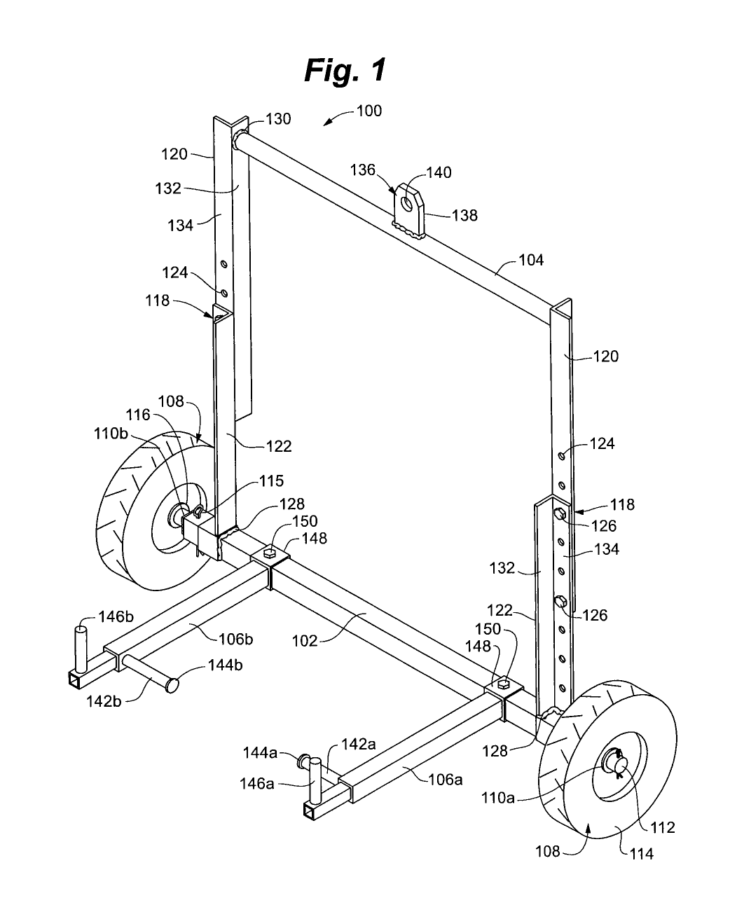

A dock dolly of the present invention is shown in one embodiment generally at 100 in FIGS. 1-3b. The dolly 100 has an axle 102 for supporting the weight of a roll-in dock 200 during the lifting and transportation of dock 200. Wheel assemblies 108 are coupled on opposite ends of the axle 102. A handle 104 that is substantially parallel to the axle 102 is rigidly coupled to the axle 102 as an interface for applying force in order to effect lifting an end of the dock 200 and transporting of dock 200. A first engaging member 106a is operably coupled to the axle 102 and extends in a substantially perpendicular direction outward from the plane defined by the axle 102 and the handle 104. A second engaging member 106b is similarly operably coupled to the axle 102 and similarly extends in a substantially perpendicular direction outward from the plane defined by the axle 102 and of the handle 104. First and second engaging members 106a and 106b extend such that they are operably couplable to the sides 201 of the dock 200.

In one embodiment, each of the wheel assemblies 108 has a circular outer rod 116 that fits inside the wheel 114. The circular outer rod 116 is coupled to a respective inner squared tube (not shown) that fits inside the axle 102. The inner squared tube is pinned by pin 115 inside the axle 102 to hold the wheel assembly 108 in place. Washers 110a and 110b on each side of the wheel 114 prevent the wheel 114 from slipping off the axle 102. Inner washer 110b is fixed to the wheel assembly 108 along circular outer rod 116. Outside washer 110a is coupled to wheel assembly with pin 112 and prevents outer washer 110a from falling off.

Handle 104 has uprights 118 positioned on opposite ends of axle 102 in order to couple handle 104 to axle 102. Each upright 118 has an upper member 120 and a lower member 122 in order to provide adjustable height to handle 104 relative to axle 102. Lower members 122 are rigidly coupled to axle 102 at joints 128 at opposite ends of axle 102. Upper members 120 are rigidly coupled to handle 104 at joints 130 at opposite ends of handle 104. Both upper members 120 and lower member 122 have an apertured face 134 and a continuous face 132. In one embodiment of one upright 118, apertured face 134 and continuous face 132 are perpendicular to each other. In such an embodiment, the plane of continuous face 132 of upper member 120 can couple to handle 104 and the aperture faces 134 of upper member 120 and lower member 122 are then aligned flush to each other, with continuous faces 132 pointed opposite each other. Fasteners 126 positioned through apertures 124 allow for the rigid coupling of upper member 120 to lower member 122 and thereby rigidly couple handle 104 to axle 102. Handle 104 also has one or more slotted flanges 136 rigidly coupled to handle 104 for attaching a cable to dolly 100. Slotted flange 136 has flange 138 and aperture 140 within flange 138 for passing a cable.

First and second engaging members 106a and 106b couple to axle 102 by utilizing squared glands 148. The interior dimensions of the squared gland 148 are shaped just larger than the outside dimensions of the axle 102 such that each of the respective inner sides of squared gland 148 make flush contact with a respective outside side of axle 102. Fastener 150 is disposed in a threaded bore (not shown) defined in gland 148 and thereby can be brought to compressively engage the axle 102, thereby securing squared gland 148 to axle 102. By this means, the first and second engaging members 106a and 106b are secured to axle 102, by exerting force through squared gland 148 onto axle 102. Conversely, once loosened, fastener 150 releases squared gland 148 and thereby allows first and second engaging members 106a and 106b to slide freely along axle 102. In an optional embodiment, no fasteners 150 are needed.

First engaging member 106a has a transverse projecting pin 142a near the distal end of first engaging member 106a that is directed inward towards second engaging member 106b. Transverse projecting pin 142a has a circular lip 144a at the distal end. Further, first engaging member 106a has an orthogonally disposed projecting pin 146a that extends orthogonally from first engaging member 106a.

Similar to first engaging member 106a, second engaging member 106b has a transverse projecting pin 142b near the distal end of second engaging member 106b that is directed inward towards first engaging member 106a. Transverse projecting pin 142b has a circular lip 144b at the distal end. Also, second engaging member 106b has an orthogonally disposed projecting pin 146b that extends orthogonally from first engaging member 106b.

Transverse projecting pins 142a and 142b, in combination with circular lips 144a and 144b are utilized in engaging dock 200 for lifting and transporting dock 200. Transverse projecting pins 142a and 142b extend through apertures defined by side members 202 of the dock 200, and circular lips 144a and 144b engage the inner margins of the side members 202 and thereby ensure the dock 20 does not become disengaged during lifting or transport. Orthogonally projecting pins 146a and 146b are utilized in engaging dock 200 for pushing dock 200.

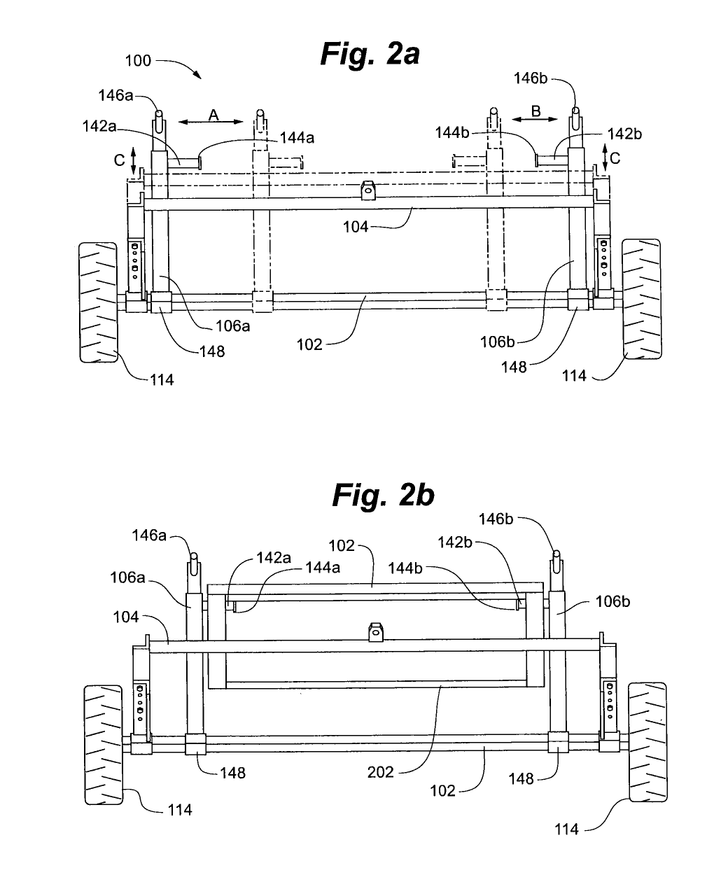

In operation, according to the first embodiment of dolly 100 as shown in FIGS. 1-3b, the dolly 100 engages dock 200 in a loading position. Referring specifically to FIG. 2a, handle 104 can rotate about the axle 102 such that first and second engaging members 106a and 106b are positioned along the sides 201 of dock 200. For example, in FIG. 2a, handle 104 rotates distance C about the axle 102 to rotate first and second engaging members 106a and 106b the same distance on the opposing sides of axle 102. First and second engaging members 106a and 106b are slidable transversely along axle 102 by means of the loosened squared glands 148. Such sliding accordingly shifts transverse projecting pins 142a and 142b and orthogonal projecting pins 146a and 146b the same distance as first and second engaging members 106a and 106b are shifted, respectively. For example, in FIG. 2a, first engaging member 106a is slid along axle 102 by distance A. Second engaging member 106b is slid along axle 102 by distance B. Once members 106a, 106b are disposed adjacent the sides 201 of dock 200 (solid lines of FIG. 2a), the engaging members 106a, 106b may be transversely shifted inward to the disposition depicted by the dashed lines of FIG. 2a and locked in place by the fastener 150. In such disposition, the pins 142a, 142b project through the apertures defined by the dock frame members 202. By operating in this manner, dolly 100 engages the dock 200. Referring to FIG. 2b, first and second engaging members 106a and 106b have been shifted such that transverse projecting pins 142a and 142b engage dock frame members 202 below a dock decking material 204. Circular lips 144a and 144b prevent dock 200 from shifting while in operation by securing the dock frame 202 against transverse projecting pins 142a and 142b.

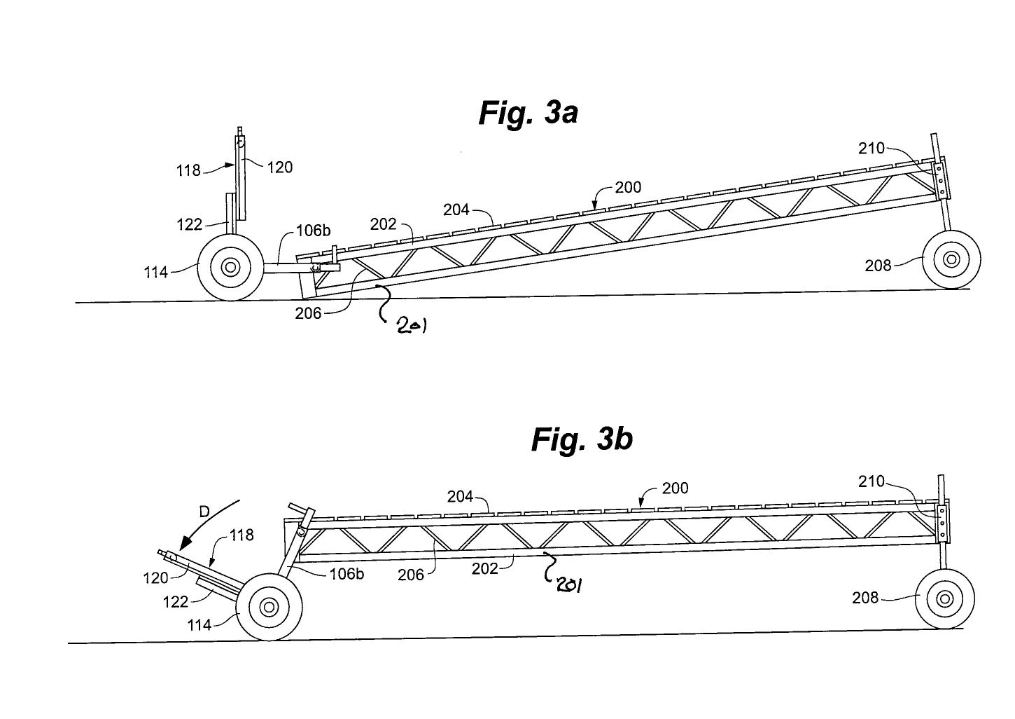

Referring to FIG. 3a, dolly 100 is shown in a loading position with dock 200. Dolly 100 is positioned opposite the rollable end of dock 200. Dock wheels 208 coupled to dock 200 at coupling 210 provide the rollable end of dock 200 and provide an effective rolling partner for wheels 114. As positioned, dolly 100 is engaged through apertures defined in the sides 201 of dock 200 by dock frame members 202 and is in contact with the side of dock frame members 202 and potentially, dock frame members 206. Uprights 118, via upper members 120, and lower members 122, are illustrated as vertical. However, uprights 118 may extend in any substantially upright position when in the loading position. Referring to FIG. 3b, force is applied in direction D along handle 104 to lift dock 200 into the transport position. The force applied in direction D is transmitted to axle 102 and subsequently lifts first and second engaging members 106a and 106b, which are in contact with dock 200 against transverse projecting pins 142a and 142b, and therefore lifts dock 200. In the transport position, the dock 200 weight is transferred to the axle 102 and wheels 114. Uprights 118 are depicted as angled in FIG. 3b and may generally be angled to whatever position makes transporting dock 200 easiest on the dolly operator. Force can then be continuously applied in direction D to dock 200 and simultaneously generally horizontal force may be applied in either direction to handle 104 to transport dock 200 either left or right in the depiction of FIG. 3b.

To push a dock 200 (translation to the right in FIG. 3b), a board (not shown), such as a 2×4 with length longer than the width of the dock 200 may be coupled to orthogonal projecting pins 146a and 146b. Dolly 100 is positioned such that the board coupled to orthogonal projecting pins 146a and 146b contacts dock 200 at dock frame 202, dock decking material 204, dock frame chords 206, or any combination thereof such that sufficient force can be applied to dock 200. Generally horizontal force can then be applied in the direction of the dock 200 to push the dock 200. Weight is transferred from dock 200 through first and second engaging members 106a and 106b and into the axle 102 and wheel assemblies 108, enabling a dolly operator to easily push the dock 200.

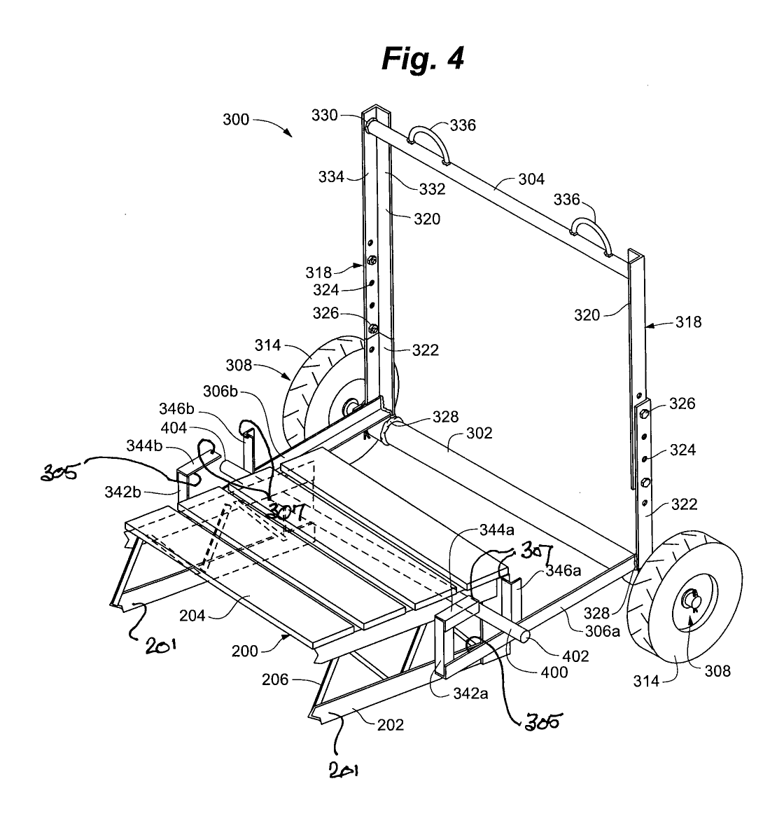

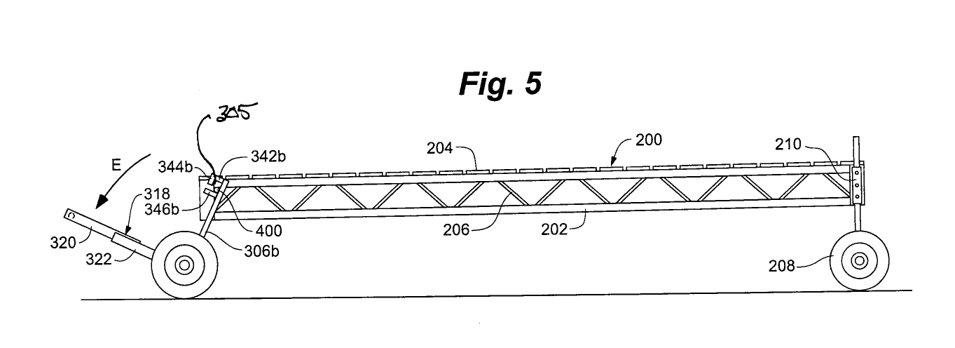

A dock dolly according to another embodiment of the present invention is shown generally at 300 in FIGS. 4-5. Dolly 300 has an axle 302 for supporting the weight of a roll-in dock 200 during the lifting of and end of the dock 200 and transportation of dock 200. Wheel assemblies 308 are coupled on opposite ends of the axle 302. A handle 304 is rigidly coupled to the axle 302 as an interface for applying force in order to effect both lifting and transporting of the dock 200. A first engaging member 306a is rigidly coupled to the axle 302 and extends in a substantially perpendicular direction outward from the plane of the axle 302 and the handle 304. A second engaging member 306b is similarly rigidly coupled to the axle 302 and similarly extends in a substantially perpendicular direction outward from the plane defined by the axle 302 and the handle 304. First and second engaging members 306a and 306b extend such that they are operably couplable to dock 200 utilizing a lifting rod 400.

The axle 302 of dolly 300 is preferably round. As such, wheel assemblies 308, including wheels 314 can be directly coupled to axle 302 without a separate wheel bracket assembly as noted above.

Handle 304 has uprights 318 positioned on opposite ends of axle 302 in order to couple handle 304 to axle 302. Each upright 318 has an upper member 320 and a lower member 322 in order to provide adjustable height to handle 304 relative to axle 302. Lower members 322 are rigidly coupled to axle 302 at joints 328 at opposite distal ends of axle 302. Upper members 320 are rigidly coupled to handle 304 at joints 330 at opposite distal ends of handle 304. Both upper members 320 and lower member 322 have an apertured face 334 and a continuous face 332. In one embodiment of one upright 318, apertured face 334 and continuous face 332 are perpendicular to each other. In such an embodiment, the planes of both continuous faces 332 and aperture faces 334 of upper member 320 are aligned flush and overlapping the corresponding continuous faces 332 and aperture faces 334 of lower member 322. In such an embodiment, the apertured face 334 can couple to handle 304. Fasteners 326 positioned through apertures 324 allow for the rigid coupling of upper member 320 to lower member 322 and therefore handle 304 to axle 302. Handle 304 also has one or more hooks 336 rigidly coupled to handle 304 for attaching a cable to dolly 300.

First and second engaging members 306a and 306b are rigidly coupled at opposite ends of axle 302. Each of the engaging members 306a and 306b includes an aperture 305 defined proximate the distal mend thereof. Each aperture 305 includes an aperture opening 307. The aperture 305 is defined by the following noted structure. Each of first and second engaging members 306a and 306b has an orthogonal projection 342 at the distal end of a respective engaging member 306a, 306b opposite axle 302. Extending from orthogonal projections 342 on each of first and second engaging members 306a and 306b are transverse projections 344 that project back toward axle 302 in the same plane as first and second engaging members 306a and 306b.

Lifting rod 400 extends from first engaging member 306a through the dock frame 202 and dock frame chords 206, under decking material 204, to second engaging member 306b. In one embodiment, lifting rod 400 is made of heavy duty steel. Lifting rod 400 provides the contacting surface for the dock frame 202. The system of parallel engaging members 306a and 306b, orthogonal projections 342 transverse projections 344 and orthogonal members 346, coupled with lifting rod 400, provide the means for lifting and transporting dock 200. Also, each of first and second engaging members 306a and 306b has an orthogonal member 346 located intermediate each of first and second engaging members 306a and 306b. Orthogonal members 346 are utilized in conjunction with a suitable board as noted above for engaging dock 200 for applying a generally horizontal pushing force to the dock 200.

In operation, according to an embodiment of dolly 300 as shown in FIGS. 4-5, dolly 300 can engage respective sides of dock 200 in a loading position. Referring specifically to FIG. 4, dolly 300 is positioned with uprights 318 substantially vertical with the dock 200 resting between first and second engaging members 306a and 306b. In such a position, the rigidly attached first and second engaging members 306a and 306b extend such that orthogonal projections 342 and transverse projections 344 extend along the sides of dock frame 202 and are disposed generally beneath decking material 204. Lifting rod 400 is threaded through the sides dock frame 202 and through the respective apertures 305 by starting at either the first or second engaging member 306a or 306b. For example, a lifting rod first end 404 is positioned at first engaging member 306a under decking material 204 and is pushed sideways through dock frame 202 and dock frame chords 206 to extend to second engaging member 306b. In such a positioning, the first end 404 of lifting rod 400 extends perpendicularly over second engaging member 306b and a lifting rod second end 402 extends perpendicularly over first engaging member 306a. Lifting bar is illustrated in FIG. 4 as having been fully threaded through dock 200. Dock 200 and dolly 300 are fully engaged in the loading position, and are ready to move to the transport position.

Referring to FIG. 5, force is applied in direction E along handle 304 to lift dock 200 into the transport position. The force applied in direction E transitions to axle 302 and subsequently lifts first and second engaging members 306a and 306b, which are in contact with dock 200 through lifting rod 400. Lifting rod 400 is captured in place by an aperture defined by projections 342, orthogonal, and transverse projections 344. In the transport position, the dock 200 weight is transferred to the axle 302 and wheels 314. Uprights 318 are depicted as angled in FIG. 5 and may generally be angled to whatever position makes transporting dock 200 easiest on the dolly operator. Force can then be continuously applied in direction E and simultaneously a force may be applied generally horizontal in either direction to the dock 200 to transport the dock 200.

To assist in pushing a dock 200 (translation to the right in FIG. 5) using dolly 300, a board as noted above may be coupled to vertical members 346. Dolly 300 is positioned such that the board coupled to vertical members 346 contacts dock 200 at dock frame 202, dock decking material 204, dock frame chords 206, or any combination thereof such that sufficient force can be applied to dock 200. A rightward directed generally horizontal force can then be applied to the dock 200 to push the dock 200 rightward. Weight is transferred from dock 200 through first and second engaging members 306a and 306b and into the axle 302 and wheel assemblies 308, enabling a dolly operator to easily push the dock 200.

The embodiments above are intended to be illustrative and not limiting. Additional embodiments are within the claims. In addition, although aspects of the present invention have been described with reference to particular embodiments, those skilled in the art will recognize that changes can be made in form and detail without departing from the spirit and scope of the invention, as defined by the claims.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims that are included in the documents are incorporated by reference into the claims of the present application. The claims of any of the documents are, however, incorporated as part of the disclosure herein, unless specifically excluded. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

1. A dolly for transporting a roll-in dock, the roll-in dock including a top decking material supported by a first side and a second side of a dock frame being formed of dock frame members, comprising:
an axle;
a handle rigidly and operably coupled substantially parallel to the axle;
a first wheel operably coupled to a first end of the axle;
a second wheel operably coupled to a second end of the axle;
a first engaging member operably coupled to the axle and extending in a substantially perpendicular direction outwardly therefrom; and
a second engaging member operably coupled to the axle and extending in a substantially perpendicular direction outwardly therefrom and substantially parallel to the first engaging member;
wherein the first and second engaging members are operably couplable to the first and second sides respectively of the roll-in dock.

2. The dolly of claim 1 wherein the handle is operably coupled to the axle by:
a first upright extending between and rigidly coupling the first end of the handle to the first end of the axle; and
a second upright extending between and rigidly coupling the second end of the handle to the second end of the axle.

3. The dolly of claim 2 wherein the length of the first and second uprights are adjustable.

4. The dolly of claim 2 wherein the first and second uprights extend from the axle relative to the first and second engaging members at an angle that is greater than 90 degrees.

5. The dolly of claim 2 wherein the first and second uprights extend from the axle relative to the first and second engaging members at an angle that is less than 90 degrees.

6. The dolly of claim 1 wherein the first and second engaging members are slidably adjustable along the axle.

7. The dolly of claim 6 further comprising:
the first engaging member further comprising a first engaging pin extending from the first engaging member outward towards the second engaging member, the first engaging pin having a distal lip; and
the second engaging member further comprising a second engaging pin extending from the second engaging member outward towards the first engaging member, the second engaging pin having a distal lip.

8. The dolly of claim 1 wherein the substantially parallel handle further comprises at least one slotted flange for coupling a cable from the dolly.

9. The dolly of claim 1 wherein the first and second engaging members are adapted to operably couple to a lifting rod, the lifting rod capable of engaging the roll-in dock through the sides of the roll-in dock under the top decking material and between the dock frame.

10. The dolly of claim 9 further comprising:
the first engaging member further comprising a first vertical projection, the first vertical projection located at an intermediate position to the first engaging member; and
the second engaging member further comprising a second vertical projection, the second vertical projection located at an intermediate position to the second engaging member;
wherein the first and second vertical projections are adapted to operably couple to a supporting board, the supporting board and first and second vertical projections capable of supporting an end of a roll-in dock in order to push the roll-in dock.

11. The dolly of claim 1 further comprising:
the first engaging member having a first vertical pin, the first vertical pin located at a distal end of the first engaging member; and
the second engaging member having a second vertical pin, the second vertical pin located at a distal end of the second engaging member;
wherein the first and second vertical pins are adapted to operably couple to a supporting board, the supporting board and first and second vertical pins capable of supporting an end of a roll-in dock in order to push the roll-in dock.

12. The dolly of claim 1 wherein the axle is a square axle.

13. A method for supporting an end of a dock and translationally shifting the dock, the dock having side frame members and being supported proximate a first end by a plurality of wheels, comprising:
forming a dolly; and
disposing first and second engaging members adjacent a respective dock side and adapting the first and second engaging members to selectively engage a respective dock side frame member.

14. The method of claim 13, including forming the first and second engaging members to be transversely shiftable; and
inward directed transverse shifting of the first and second engaging members from the disposition adjacent a respective dock side effecting disposing a respective projecting pin operably coupled to the engaging member in an aperture defined in a respective side of the dock.

15. The method of claim 13 including generally transversely disposing a rod relative to the dock and passing the rod passing through the respective side frame members and engaging each of the first and second engaging members.

16. A dolly for supporting an end of a dock and translationally shifting the dock, the dock having side frame members and being supported proximate a first end by a plurality of wheels, comprising:
first and second engaging members disposable adjacent a respective dock side, the first and second engaging members being adapted to selectively engage a respective dock side frame member.

17. The dolly of claim 16 wherein the first and second engaging members are transversely shiftable whereby inward directed transverse shifting thereof from the disposition adjacent a respective dock side effects disposing a respective projecting pin operably coupled to the engaging member in an aperture defined in a respective side of the dock.

18. The dolly of claim 16 wherein a rod is generally transversely disposed relative to the dock, the rod passing through the respective side frame members to engage each of the first and second engaging members.

19. The dolly of claim 16 including a handle operably coupled to the first and second engaging members, the handle being shiftable to impart a lifting force on the respective first and second engaging members.

20. The dolly of claim 19, wherein the handle is operably, fixedly coupled to an axle, the axle mounting a wheel at each of two axle ends whereby the lifting force extended on the respective first and second engaging members acts to cause end of the dock to be borne on the wheels.
